(19) United States
(12) Patent Application Publication
(10) Pub. No.: US 2005/0018877 A1
(43) Pub. Date: Jan. 27, 2005

(54) Method and device for processing graphic information located on surfaces of postal articles

(76) Inventors: Peter Fery, Zwingenberg (DE); Jurgen Helmus, Bonn (DE); Gunther Meier, Reinheim (DE); Dieter Stumm, Grossefehn (DE); Carsten Vullriede, Hodenhagen (DE)

Correspondence Address: MARSHALL, GERSTEIN & BORUN LLP, 6300 SEARS TOWER, 233 S. WACKER DRIVE, CHICAGO, IL, 60606, US

(21) Appl. No.: 10/492,832

(22) PCT Filed: Oct. 15, 2002
(86) PCT No.: PCT/DE02/03864

(30) Foreign Application Priority Data
Oct. 16, 2001 (DE) 101 50 457.8

(51) Int. Cl. G06K 9/00

(52) U.S. Cl. 382/101

(57) ABSTRACT

Disclosed herein are a method and device for processing graphic information located on surfaces of postal articles. Graphic information is detected in one or more processing stations and transmitted to an image processing unit where it is further processed.

The invention relates to a method for processing mailpieces, whereby graphic information present on the mailpieces is detected and evaluated.

The invention also relates to a device that is suitable for carrying out the method.

The invention is based on the objective of carrying out the processing of the graphic information reliably and at a speed that is suitable for large-scale operations in mail centers.

According to the invention, this objective is achieved in that the graphic information present on the surface of the mailpieces is detected in several processing stations, transmitted to an image processing unit and further processed by the image processing unit.

Another increase in the speed of the processing of the graphic information can advantageously be achieved in that the graphic information present on the surface of the mailpieces is first evaluated locally, in that it is ascertained whether the graphic information differs from the expected graphic information and in that, if the ascertained graphic information differs from the expected graphic information, the ascertained graphic information is transmitted to a central image processing unit.

It is especially advantageous for the mailpieces to be sorted as a function of the determined graphic information.

The graphic information present on the mailpieces is preferably also used for other applications, for example, in order to achieve a fast and reliable addressing of the mailpieces.

Another advantageous improvement of the invention is characterized in that the payment made for the mailpieces is checked by comparing the graphic information present on the mailpieces to the expected graphic information.

In order to further increase the efficiency of this method, it is advantageous for the checking procedure to ascertain whether the mailpieces have an expected payment to be performed in two stages, whereby first of all, the graphic information present on the mailpieces is compared to the expected graphic information locally in the area of the processing machines, and for the graphic information of the mailpieces in which differences between the existing graphic information and the expected graphic information were ascertained in the local processing station to undergo another comparison between the ascertained graphic information and the expected graphic information in the central image processing unit.

Mailpieces having different postage values can be processed in that the graphic information present on the surfaces of the mailpieces is associated with one or more expected types of postage and in that the checking procedure is carried out in reading devices that are specialized for the different franking modalities.

Here, it is especially advantageous for the graphic information to be associated with the reading devices by the central image processing unit.

Examples of the presented specialized reading devices are devices that can ascertain the coded data contained in the graphic information by decrypting the code and that can compare this with other data. For example, such specialized reading devices can serve to detect coded information contained in digital postage indicia.

Such reading devices are examples of image processing stations in devices that are suitable for carrying out the method.

An especially suitable device for processing mailpieces with several processing machines for the mailpieces, whereby the processing machines contain means for detecting graphic information present on the mailpieces, is characterized in that the means for detecting the graphic information are connected to at least one means for processing the graphic information in such a way that the means for processing the graphic information can process the graphic information of several processing machines.

Additional advantages, special features and practical refinements of the invention ensue from the subclaims and from the following presentation of preferred embodiments.

In the embodiment presented below, a processing center for mailpieces, for example, a mail center or shipment center, has a central image processing unit. This embodiment is especially advantageous since it allows the most effective possible use of computing capacity while using a small volume of data transmissions between the various computer units.

However, the invention is not limited to the examples presented. For example, a processing center for mailpieces can contain several central image processing units or else a central processing unit can process the graphic information from several mail centers or shipment centers.

In the following example, the image processing system with other components is connected to a local computer network within a mail center.

The image processing system has a connection to the appertaining image processing machines, especially to the address reading machines or to the video coding stations.

In the case being presented here, the image processing system serves to process mailpiece images that could not be successfully read by the primary readers of the image processing machines. As an alternative, it is essentially possible to process the mailpiece images of all primary readers with the central image processing unit. For example, this processing can be carried out independently of the reading result of the primary readers.

The image processing system receives the graphic information that is present on the mailpieces and preferably also accompanying information from the image processing machines.

An especially fast and reliable processing of the mailpieces can be achieved in that the accompanying information contains results of one or more checking steps for the mailpieces.

The graphic information present on the mailpieces can be processed sequentially as well as in parallel.

In particular, it is advantageous to carry out the method in such a way that existing image processing capacities are utilized as efficiently as possible by an effective distribution of the image processing tasks among various image processing units.

In the image processing system being presented here, the local image processing units that are connected to the processing machines function as primary readers and the specialized reading units function as secondary readers. However, it is likewise possible for the image processing units of other processing machines to function as secondary readers. In this manner, the momentary available processing capacity of the image processing devices is utilized.

Such an approach is especially suitable for a rapid adaptation of the image processing capacities to special circumstances during operations. For example, in case of a malfunction of mechanical components of a mail processing machine, its image processing capacity can be utilized by the other image processing machines so that, even during operational failures, the processing of the mailpieces is hindered to the smallest extent possible.

Through the measures presented, the image processing operation can be carried out quickly, efficiently and reliably.

Preferably, the image processing operation comprises the following steps:

First of all, the graphic information present on the mailpieces is detected, for example, by means of one or more sensors and/or by a camera.

If the information is not already acquired in digital form, then a digitalization of the graphic information is advantageous.

Subsequently, the graphic information undergoes one or more image processing steps.

The image processing steps can comprise an evaluation of the graphic information as well as a systematic transmission of the graphic information to an image processing unit that is specialized and/or one that has free processing capacity.

Therefore, the term image processing, or image processing unit, is not to be understood in any limiting manner whatsoever. In particular, it comprises the transformation of the graphic information into additional graphic information, for example, its conversion into another format, the transmission of graphic information and/or the evaluation of additional data that is contained in the graphic information or else that can be obtained from the graphic information, such as the reading of a recipient address or the decrypting of coded data contained in the graphic information.

Moreover, the term image processing also comprises the features that are occasionally designated in the realm of image processing as image interpretation. This encompasses, for example, the decrypting of recipient addresses by reading the graphic information indicating the recipient address (for example, in handwriting).

Preferably, the breakdown of the various image processing steps among various image processing units as a function of the specification of each image processing unit and/or the free capacity of the image processing units.

For example, the mailing sequence for mailpieces that contain digital postage indicia can be carried out as follows:

In a first image processing unit, which is preferably associated with one of the processing devices for mailpieces, first of all, a separate process routine checks whether the local image processing unit has sufficient processing capacity for processing the graphic information present on the mailpiece.

If this is not the case, then the graphic information is transmitted to another image processing unit that has free processing capacity.

Even in those cases where the image processing unit that is associated with the processing machine for the mailpiece has a capacity that is sufficient for processing the image data, the transmission of the detected graphic information is advantageous for certain mailpieces.

The transmission of the graphic information is especially advantageous when the graphic information partially or completely matches a specific postage indicium. In particular, such a transmission is advantageous when the graphic information matches a specific franking modality, for example, a sender franking or a digital franking.

The image data of such mailpieces is transmitted to the readers that are specialized for the various franking modalities of sender franking and digital postage indicia (PC-franking).

If the presence of such a type of postage is recognized, the appertaining checking steps are carried out.

For example, the sender franking reader, as an example of a specialized reading device, receives the mailpiece image from the central image processing unit.

The sender franking reader subsequently searches for a sender franking within an expected franking zone. The imprint of the sender franking preferably consists of three parts among which the sender franking reader recognizes the postage indicium.

Preferably, these are the payment stamp imprint recognized by the stamping machine, or the date stamp imprint and the additional field for sender information and advertising.

The sender franking reader recognizes the payment stamp imprint in its entirety and identifies it on the basis of one or more suitable graphic symbols, for example, a Post Horn contained in the payment stamp.

Subsequently, the sender franking reader reads the identification of the payment stamp and the imprinted payment amount.

In case the franking stamp imprint cannot be read or does not match an expected stamping imprint, a warning report is generated.

Such a warning report can preferably be in the form of a suitable payment assurance code; for example, as a so-called payment assurance coding, it can indicate a possible reason to suspect forgery.

Examples of such a payment assurance coding is the information that the identification or the postage indicium are not readable.

With the use of digital postage indicia, encrypted information contained, for example, in the postage indicium is compared to the unencrypted information present on the appertaining mailpiece.

In case of deviations, for example, in case the mailpiece contains a recipient address that does not match the encrypted addresses contained in the digital postage indicium, the mailpiece in question is likewise provided with a payment assurance code.

The mailpieces provided with such a payment assurance code can be processed by suitable additional checking steps and/or systematically diverted from the mailing sequence.

The image processing method presented here is especially suitable for such use in a payment assurance system but it can also be used for a more effective control of the processing of the mailpieces.

1. A method for processing mailpieces in an area of a mail processing station, the method comprising the steps of:
(a) detecting graphic information present on a surface of a mailpiece, the information comprising postage type;
(b) examining the information;
(c) transmitting the information to an image processing unit; and,
(d) checking the type of postage.

2. The of claim 1, wherein step (c) further comprises reading the information with at least one available, specialized reader.

3. (Canceled).

4. The method of claim 1, wherein step (b) further comprises (i) ascertaining whether the detected graphic information differs from the expected graphic information, and (ii) transmitting the ascertained graphic information that differs from the expected graphic information to a central image processing unit.

5. The method of claim 4, wherein the expected graphic information comprises payment information.

6. The method of claim 5, wherein the checking step (d) further comprises ascertaining whether a mailpiece has an expected payment by comparing the graphic information present on the mailpieces to the expected graphic information, locally in the area of the mail processing station, and when differences exist, further comparing the ascertained graphic information to the expected graphic information with a specialized reader.

7. The method of claim 1, wherein a mail processing station carries out the transmitting step (c) and the transmitting step (c) further comprises transmitting accompanying information to the image processing unit.

8. The method of claim 7, wherein the accompanying information comprises results ascertained by a the mail processing station in one or more checking steps for the mailpiece.

9. The method of claim 1 further comprising sorting the mailpieces as a function of the detected graphic information.

10. A method for processing mailpieces in several mail processing stations, the method comprising the steps of:
(a) detecting, in each of the several mail processing stations, graphic information present on a surface of the mailpieces;
(b) transmitting the information to an image processing unit;
(c) processing the information with an image processing unit;
(d) comparing the graphic information present on the mailpieces to expected graphic information, and;
(e) ascertaining whether the mailpieces have an expected payment by
(i) comparing the graphic information present on the mailpieces to the expected graphic information, locally in the area of the processing stations, to determine differences and, when differences exist,
(ii) further comparing the ascertained graphic information to the expected graphic information in a central image processing unit.

11. A device for processing mailpieces, the device comprising:
a several mail processing stations each comprising a detector capable of detecting graphic information present on a surface of a mailpiece; and,
(b) at least one image processing unit capable of associating the graphic information with an expected type of postage and a transmitter capable of transmitting the graphic information to a specialized reader.
wherein each station is connected to at least one image processing unit.
